(19) United States
(12) Patent Application Publication
(10) Pub. No.: US 2009/0005019 A1
(43) Pub. Date: Jan. 1, 2009

(54) Location Specific Communications

(76) Inventors: Jagrut Patel, Sayreville, NJ (US); Sumeet Suri, San Diego, CA (US); Vittal Prabhu, State College, PA (US)

Correspondence Address: Arent Fox LLP, 555 West Fifth Street, 48th Floor, Los Angeles, CA, 90013, US

(21) Appl. No.: 12/161,333

(22) PCT Filed: Jan. 18, 2007
(86) PCT No.: PCT/US07/60718

§ 371 Date: Jul. 17, 2008

Related U.S. Application Data
(60) Provisional application No. 60/766,436, filed on Jan. 19, 2006.
(60) Provisional application No. 60/766,513, filed on Jan. 24, 2006.

(51) Int. Cl. H04M 11/04

(52) U.S. Cl. 455/414.2

(57) ABSTRACT

A Specific Location Space Communication System which provides information to subscriber as function of their location and group memberships. A receiver device gets messages from space and/or aerial communication station which are selectively passed to the subscriber based on set parameters in the receiver message and more. Further, the receiver devices with transmitting capability can provide status, location and memory data to multitude of terrestrial, aerial and space based receivers. Further, the received message is classified in to an emergency alert message, advertising message, commerce message, control message etc.

### CROSS-REFERENCE TO RELATED APPLICATIONS

This application is related to U.S. Provisional Application Ser. No. 60/766,436, filed Jan. 19, 2006, entitled “Specific Location Space Communication System,” and U.S. Provisional Application Ser. No. 60/766,513, filed Jan. 24, 2006, entitled “Emergency Alert Subscriber System”, which are attached hereto as an Appendix and incorporated herein by reference as though set forth in full.

### BACKGROUND

1. Field

The present disclosure relates generally to communication systems, and more particularly, to systems and techniques for location specific communications.

2. Background

Current emergency alert systems are inadequate for fully alerting the public about natural disasters, or terrorist attacks or, for providing information on how to respond. It has become obvious after Sep. 11, 2001, the south-east Asian tsunami on Dec. 26, 2004, and again after Hurricane Katrina struck the Gulf Coast, that the ability to communicate after a disaster also has a critical role in saving lives. The two mainstays of the United States' ability to issue warnings are the Emergency Alert System (EAS), which relies primarily on broadcasting media, and the National Oceanic and Atmospheric Administration (NOAA) Weather Radio All-Hazards Network. The National Weather Service (NWS) of the NOAA sends alerts through NOAA Weather Radio (NWR), now expanded to include warnings for all hazards.

Much of the current effort in emergency communication technology is focused on interoperability of the communication infrastructure used by the various law enforcement agencies and the first responders. However, one of the key shortcomings in the current approaches is that they do not fully include the citizens under crisis. In order to effectively integrate and include citizens in crisis mitigation strategies and architecture, the infrastructure and devices used by them on a daily basis should be leveraged. Furthermore, such a solution should have the appeal of ease of use, low cost, scaleable and disaster tolerant.

### SUMMARY

An aspect of a communications device is disclosed. The communications device includes a receiver module configured to receive a message with location information, a location module configured to determine the location of the communications device, and an interface configured to provide the message to a user only when the communications device is within the location specified by the location information.

Another aspect of a communications device is disclosed. The communications device includes means for receiving a message with location information, means for determining the location of the communications device, and means for providing the message to a user only when the communications device is within the location specified by the location information.

A method of communications with a communications device is disclosed. The method includes a receiving a message with location information, determining that the communications device is within the location specified by the location information, and providing the message to a user in response to the determination that the communications device is within the location specified by the location information.

Computer readable media is disclosed. The computer-readable media contains a set of instructions for a processor in a communications device to communicate. The communications device is configured to receive a message with location information. The instructions include a routine to determine the location of the communications device, and a routine to provide the message to a user only when the communications device is within the location specified by the location information.

### BRIEF DESCRIPTION OF DRAWINGS

Aspects of the present invention are illustrated by way of example, and not by way of limitation, in the accompanying drawings wherein:

FIG. 1 is a block diagram illustrating an example of a communications device;

FIG. 2 is a block diagram illustrating another example of a communications device;

FIG. 3 is a block diagram illustrating an example of a communications device capable of sending back information to multitude of satellite and/or terrestrial broadcast station;

FIG. 4 is a block diagram illustrating an example of a communications device capable of receiving weather band and/or all hazard warning information;

FIG. 5 is a pictorial representation illustrating an example of some of the operational modes for the communications device;

FIG. 6 is a timing diagram illustrating an example of the Slotted Mode operation of the communications device;

FIG. 7 is a high level flow diagram illustrating an example of the steps performed by the communications device;

FIG. 8 is a pictorial representation illustrating an example the different types of payloads in a message received by a communications device;

FIG. 9 is a conceptual block diagram illustrating an example of a communications device receiving advertising content;

FIG. 10 is a pictorial representation illustrating examples of the received content;

FIG. 11 is a conceptual diagram illustrating an example of a communications system distributing advertising content;

FIG. 12 is a conceptual block diagram illustrating an example of the communications device that uses differential time delay of received signals from satellites;

FIG. 13 is a conceptual diagram illustrating an example of the communications device configured as a cellular phone and satellite radio;

FIG. 14 is a conceptual diagram illustrating an example of the communications device configured as a cellular phone and a weather band radio; and

FIG. 15 is a conceptual diagram illustrating the communications device split into two or more separate modules.

### DETAILED DESCRIPTION

The detailed description set forth below in connection with the appended drawings are intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well-known structures and components are shown in block diagram form in order to avoid obscuring the concepts of the invention.

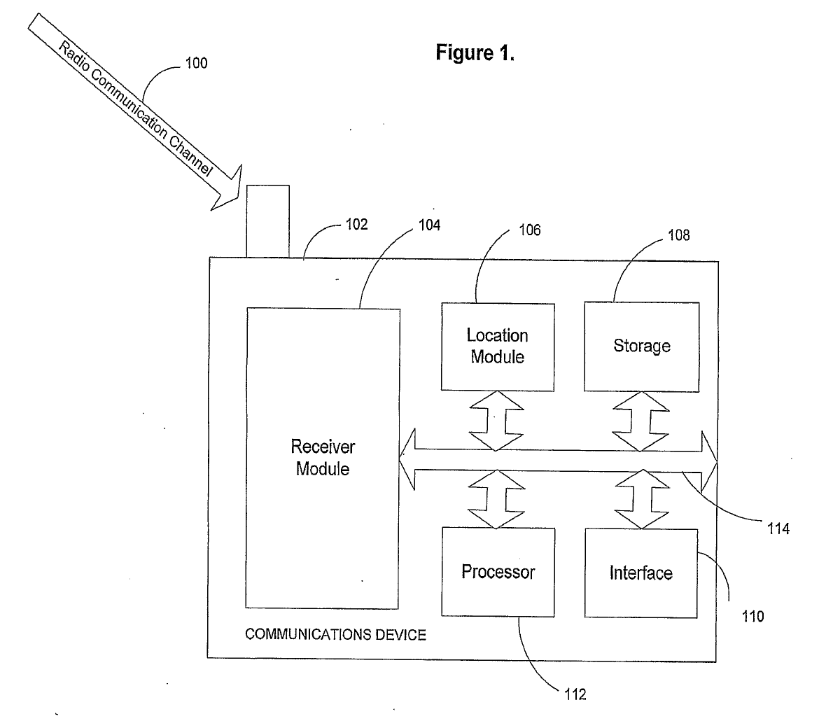

FIG. 1 is a block diagram illustrating an example of a communications device. In its simplest form, this communications device 102 contains in any combination of, but not limited to, a receiver module 104, a location module 106 with an optional GIS integration capability, a processor 112, storage 108 and an interface 110. Further, some of the modules in the communications device 102 may be integrated into one chipset for tighter integration.

The personnel skilled in the art may realize that a processor 112 may be, with no loss of generality or specificity, and in any combination of, but not limited to, an embedded processor(s), DSP, microprocessor, etc. Further, receiver module 104 includes, but not limited, and in any parts or combinations of, an AM/FM receiver, Cellular Modem (GSM, EDGE, GPRS, CDMA, WCDMA, and OFDM etc.), Pager, Satellite Radio Receiver, Satellite Modem, Digital Audio Broadcast Receiver, HD Radio Receiver, Marine Radars, CWB, CDPD, XM Radio, Sirius Radio, World Space Radio, Satellite Phone, HS3 etc. Further, the location module 106 can consist of, various components such as, but not limited to, Global Positioning System, non-GPS based positioning systems, Satellite Based Positioning System, Time Difference Receivers, Local Positioning System, Cell Site ID, signal strength based location estimation, Cell Site triangulation system, manually entered coordinates, zip Code, zip code+4, city name, telephone area code, Telephone Area Code+Exchange code, Television Signal based Location Estimation, etc.

The communications device 102 can be with no loss of generality or specificity operates as a stand-alone device, embedded inside consumer electronic device, interfaced with consumer electronic device, etc. The consumer electronic devices may include but not limited to, and in any parts or combinations of cellular phone, usb stick, fire alarm, satellite radio, am/fm radio, weather radio, TV, computer, laptop, PDA, navigation, telephone, pagers, satellite pagers, etc,

The communications device 102 in FIG. 1, shall receive and process messages sent over radio communication channel 100. The message may contain location information in which case message will be played or displayed to the Subscriber depending on the nature of the message, provided, the communications device 102 is located within the location code specified in the message.

The applications for the communications device 102 can consist of but not limited to, and in parts or combination of roadside assistance, emergency alert notification, location aware advertisement, location aware commerce, location aware communication, location aware multimedia, law enforcement, remote monitoring, remote tracking, etc.

To the person skilled in the art, it will be apparent that a message may be broadcast by AM/FM station, satellite radio, satellite pager or cellular broadcast to the communications device 102, where the communications device 102 receives the message and process the content of the received message using the receiver module 104 and then the processed message is sent to the processor 112 for further processing. The processor 112 determines if the received message is location sensitive in which case, it determines current location from the location module 106, performs instructions described in the received message if the current location of the receiver device 102 is within the area specified by the received message. The location module 104 may determine its current location by performing GPS, search, use cell site ID as a reference to determine its location, or use statically stored zip code/city name to determine its location.

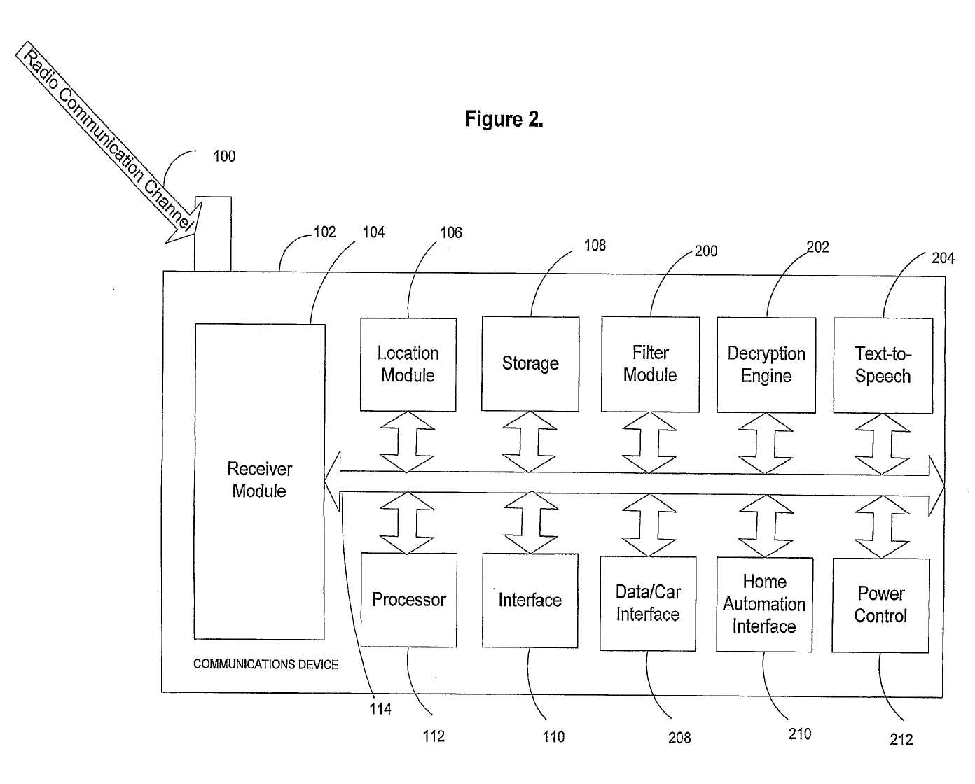

FIG. 2 is a block diagram illustrating another example of a communications device. The communications device 102 in FIG. contains in any combination of, but not limited to, receiver module 104, location module 106 with optional GIS capability, one or more processors 112, storage 108, interface 110, filter module 200, decryption engine 202, text-to-speech converter 204, power control 212, data/car interface module 208, and home automation interface module 210.

The filter module 200 provides enhanced capability of providing various roles based filters such as, but not limited to, Fire, EMS, Police, FEMA, Citizen, Red Cross, Doctors, Nurses, Government. The received message may contain group(s) for which the message is intended. The communications device 102 may contain group memberships with one or more functional groups which may be statically assigned during manufacturing, or by software configuration, or dynamically programmed over radio communication channel, or entered manually. The filter module 200 may also contain a secret key which enables communications device 102 to authenticate the source of message. If the source is not verifiable, the received message is discarded.

The received message may be encrypted for security purpose. The decryption engine 202 is used to decode such encrypted messages. The personnel skilled in the art may realize that the transmitted message may be encrypted using identifiers such as, but not limited to, with parts and any combination of, group ID, subscriber ID, location code, etc.

Depending on the subscriber settings or, or received message configuration, the received message may be converted to audio or voice using the text-to-audio converter 204. It will be apparent to skilled personnel in the art that the received message can be played to the subscriber in multiple languages.

The data/car interface module 208 is used to interface communications device 102 to various equipments such as, but not limited to, with no loss of specificity or generality, and in parts or any combination of, highway signs, nuclear, biological, and chemical (NBC) Detectors, traffic lights, public address systems, etc. Similarly, the data/car module 208 may also be used to interface the communications device 102 to devices commonly seen in cars, but not limited to, with no loss of specificity or generality, and in parts or any combination of, navigation systems, AM/FM radio, weather radio, satellite radio, car phone, MP3 players, etc.

The home automation interface 210 enables the communications device 102 to interface to common house hold security appliances such as, but not limited to, fire alarms, home security systems, appliances, telephone, home based alert systems, etc.

The power control 212 is capable of operating the receiver in various modes including but not limited to low power mode, battery operated mode, wall plugged mode, etc.

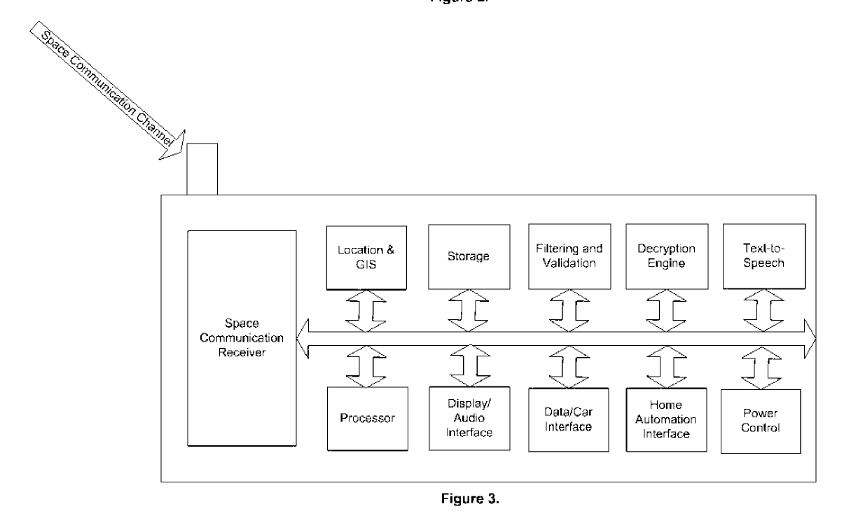

FIG. 3 is a block diagram illustrating an example of a communications device capable of sending back information to multitude of satellite and/or terrestrial broadcast station. The message transmitted by transceiver module 104 can include information such as, but not limited to, location information, data from data/car interface module, memory content, loop-back, etc.

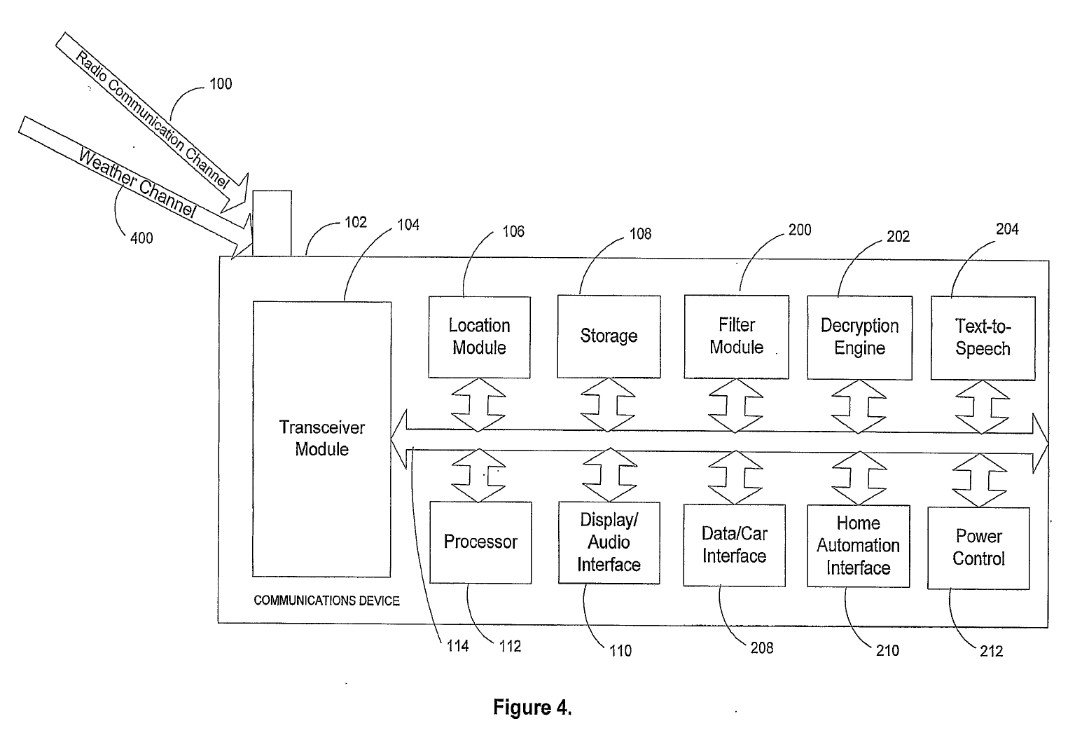

FIG. 4 is a block diagram illustrating an example of a communications device capable of receiving weather band 400 and/or all hazard warning information transmitted by, but not limited to, NOAA/NWS and other such agencies. The communications device 102 is capable of alerting subscriber to threat broadcasted on weather radio band specific to the subscriber location.

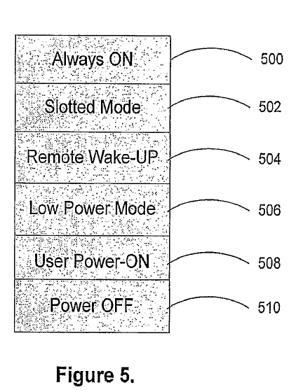

FIG. 5 is a pictorial representation illustrating an example of some of the operational modes for the communications device. In the Always-ON 500 mode of operation, the communications devices 102 is constantly looking for incoming messages. In the Slotted Mode 502, the communications device 102 sleeps for a specific duration between messages to save power. The sleep duration can be fixed or dynamically changed based on the configuration received from incoming message. Remote Wake-Up Mode 504 serves the purpose of waking-up the communications device 102 and also any of the associated consumer devices which are interfaced to the communications device 102. This will ensure delivery of message to the subscriber. The Low Power Mode 506 saves battery power by performing device specific operations such as but not limited to frequency throttling, voltage throttling, enforced slotted mode, voltage staggering, selective power-off etc. The received message carries information about remote Power-OFF 510 of the consumer devices associated with the communications device 102. The personnel skilled in the art will realize that the communications device 102 can perform auto-tuning of associated radio channels. Further, the communications device 102 with a transceiver module can send SOS message(s) based on location or group association when request is made in the received message or at a programmed interval of time or both.

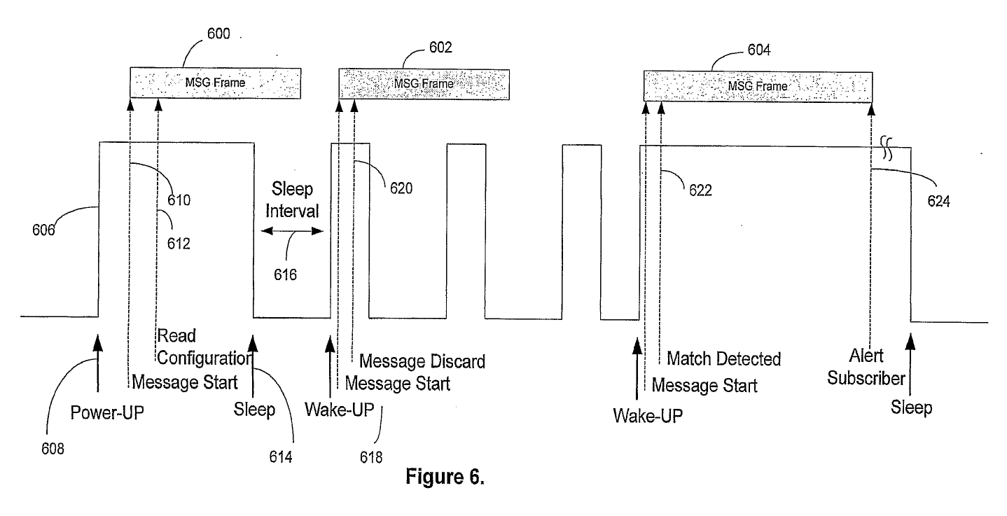

FIG. 6 is a timing diagram illustrating an example of the Slotted Mode 502 operation. The communications device 102 performs initialization and built-in-self-test at power-up 608. The communications device 102 waits for the incoming message 600, from which it extracts the configuration information. To the person skilled in the art, it will be apparent that such configuration stored in the storage 108 (see FIG. 1) during factory configuration or on the first boot-up and retrieved as an when required by the communications device 102. Further, such configuration may be sent dynamically to the communications device 102 by embedding the information in the received message. Such configuration information may be embedded in every frame or on every n^{th} frame. The configuration information help synchronize the incoming message 600 and the communications device 102. This is used for calculating the sleep interval 616 during which the communications device 102 can turn to low power mode 506 for conserving power. Thus, upon power-up 608, the communications device 102 waits for the message start 610 to start the receiving and decoding of the incoming message 600. The communications device 102, decodes the configuration information and calculates a sleep interval 616. The communications device 102 switches to low power mode 506 to conserve power as soon as it is determined that the received message does not meet various addressing criteria's for the communications device 102. In such a case, the message is discarded 620. If the received message passes all the set addressing criteria's for the communications device 102, the subscriber is alerted to the incoming message 624 after which the device sleeps for a sleep interval 616.

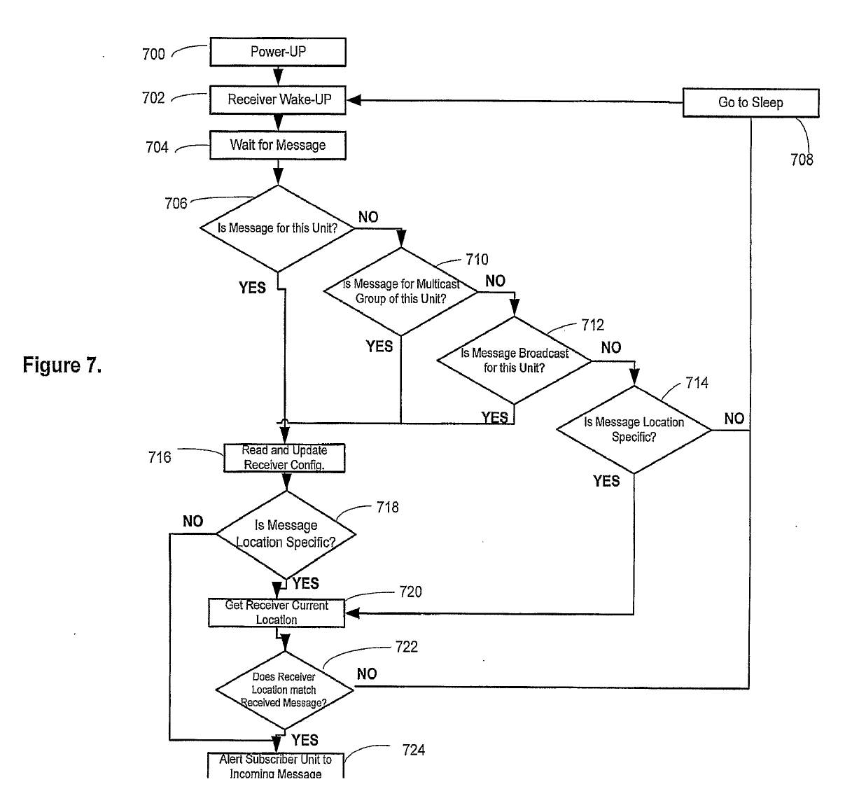

FIG. 7 is a high level flow diagram illustrating an example of the steps performed by the communications device 102 to process the message described in FIG. 6. On power-up 700, the communications device 102 is initialized to a wake-up 702 state where the communications device 102 waits 704 for the incoming message. If the address field in the received message matches the communications device 102 identification number 706 or the group addressing field 708 or if it's a broadcast message 710, the communications device 102 updates device configuration information if certain bit-fields are set to require configuration update. The communications device 102 the checks if the received message is coded with location information 718 upon presence of which the communications device 102 checks for its current location 720 to determine if the communications device 102 is presently located in the region for which the received message is intended. Upon successful match, the subscriber is notified to the incoming message 724. Failure to meet any conditions will result in the discarding of the incoming message and configuring the communications device 102 to a low power mode 708, in which case communications device 102 will shut down operations until the sleep interval 616 duration is expired after which the communications device 102 is initialized to listen for incoming messages 702. It shall be apparent to the person skilled in the art that the received message may be addressed with any combinations of device identification number, multicast group, broadcast, location, etc. and that the communications device 102 is required to satisfy all the one or more destination addresses in the received message in order to alert the subscriber 724.

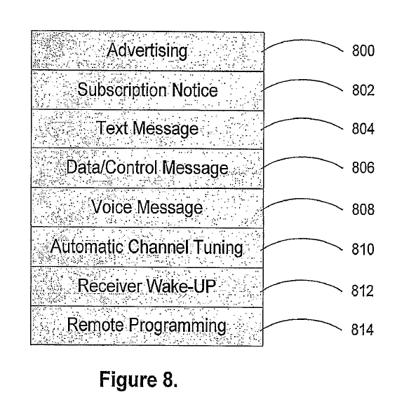

FIG. 8 is a pictorial representation illustrating an example the different types of payloads in the received message. The payloads may include, but not limited to, and in any combination of, advertising 800, subscription notice 802, text message 804, data/control message 806, voice message 808, automatic channel tuning 810, receiver wake-up/power-OFF 812, and remote receiver programming 814, etc. with no loss of generality or specificity.

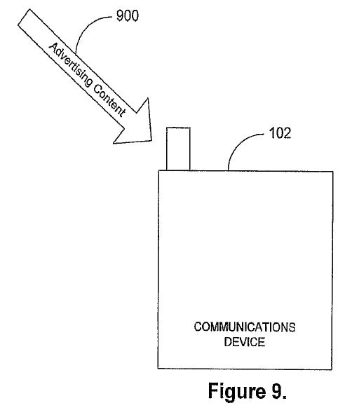

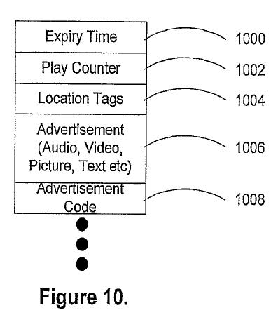

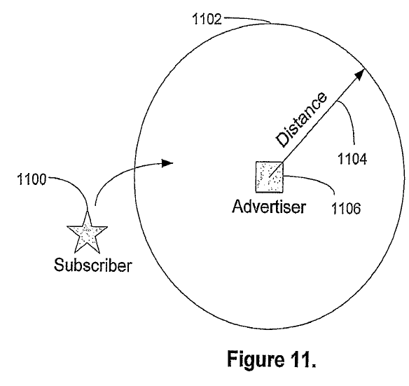

FIG. 9 is a conceptual block diagram illustrating an example of a communications device receiving advertising content. In this example, the advertising content 900 is received by the communications device 102 and the content is saved in the storage 108 (see FIG. 1) as function of communications devices 102 current location. FIG. 10 is a pictorial representation illustrating examples of the received content, which includes information such as, but not limited to, and in any combination of, expiry Time 1000, number of repeats 1002, location tag(s) 1004, advertisement (pictures, text, video, audio etc) 1004, advertising code and coupons 1008, etc., with no loss of generality or specificity. Referring to FIG. 11, as the subscriber 1100 on the communications device 102 enters certain proximity to the advertiser 1106, the corresponding stored advertising content is presented to the subscriber in one or more form (e.g., images, text, audio, video etc.).

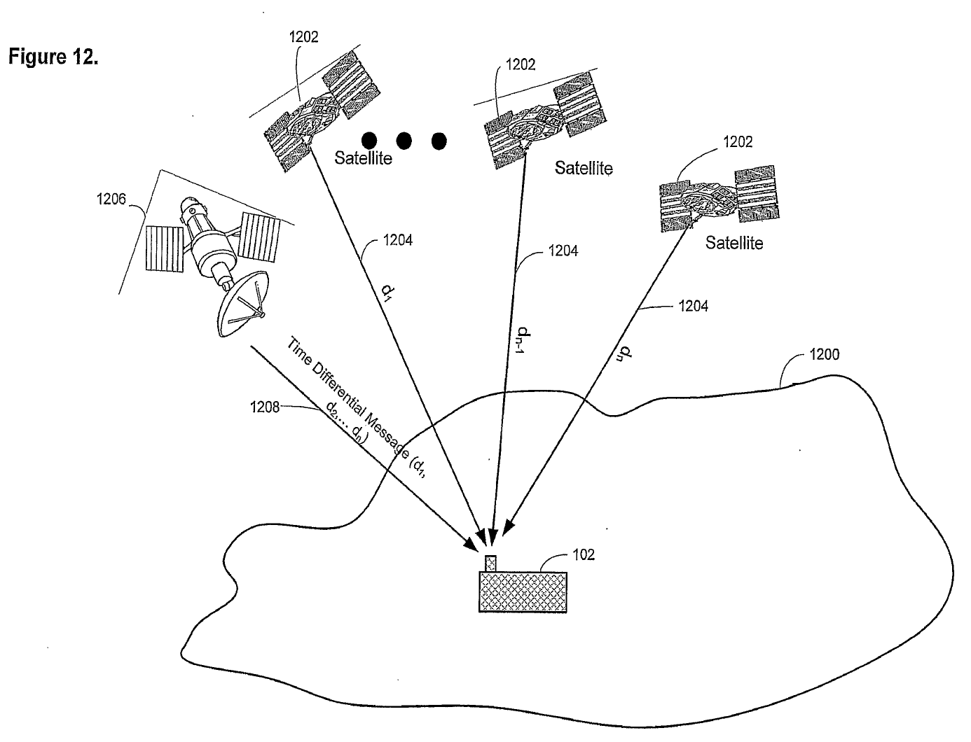

An example of the communications device that uses differential time delay of received signals from satellites to compute the relevance of the message is shown in FIG. 12. The communications device 102 monitors propagation delay 1204 of time synchronous signals from various satellites 1202. The received message 1208 contains range of propagation delay allowed for each satellite. The location module 104 (see FIG. 1) in the communications device 102 computes if the measured propagation delay 1204 falls within the specified range of allowed propagation delay to determine the location match. The communications device 102 communicates the message to the subscriber when a valid address match is detected.

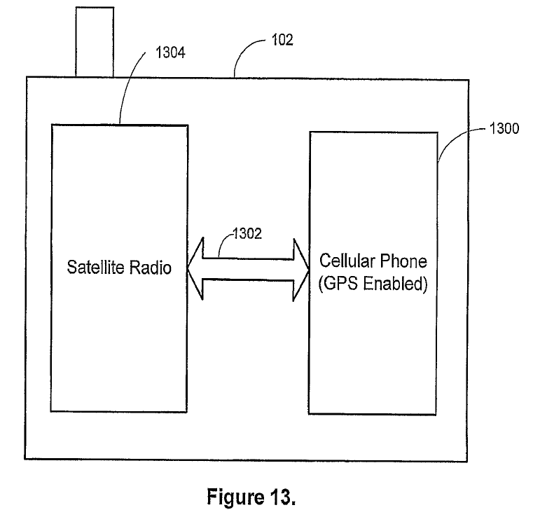

FIG. 13 is a conceptual diagram illustrating an example of the communications device configured as a cellular phone and satellite radio. To the person skilled in the art, both of these features may be designed to share features such as but not limited to with no loss of generality or specificity and in parts of or any combinations of antenna, RF, processor(s), battery management, software, firmware, subscriber interface, display, audio, positioning system and other components. Further, the satellite radio 1304 functionality may be controlled using the cellular phone 1300 and vice versa. Further, the satellite radio 1304 may be used to provide emergency alert message(s) to the cellular phone subscriber. Further, the satellite radio 1304 may be used to provide location specific emergency alert messages to the cellular phone subscribers. Further, the satellite radio 1304 may be used to broadcast text messages to cellular phone subscribers. Further, the cellular phone application may be used for keeping track of usage of the communications device. Further, the cellular phone application may be used for On-Demand music delivered via the satellite radio 1304. Further, the cellular phone application may be used for browsing programming content on the satellite radio 1304. Further, the cellular phone application may be used in the process of billing for the satellite radio 1304. Further, the cellular phone application may be realized with no loss of generality or specificity and implemented in parts or any combination of hardware, software, device driver, firmware, OS, etc.

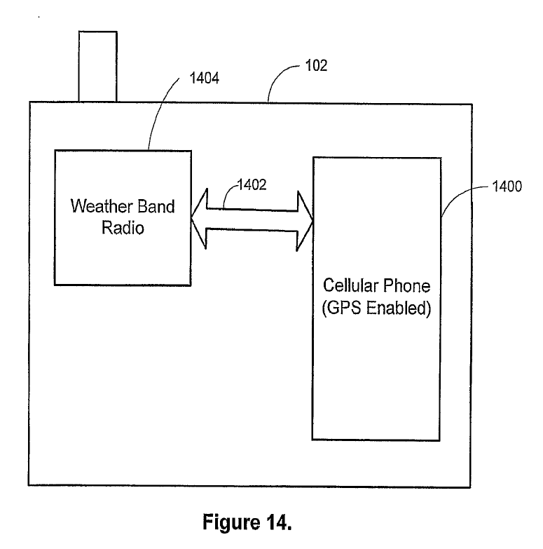

FIG. 14 is a conceptual diagram illustrating an example of the communications device configured as a cellular phone and a weather band radio. The weather band radio 1400 is the receiver module 104 (see FIG. 1) in the communications device 102. To the person skilled in the art, both of these features may be designed to share features such as but not limited to with no loss of generality or specificity and in parts of or any combinations of antenna, RF, processor(s), battery management, software, firmware, subscriber interface, display, audio, positioning system and other components. Further, the weather band radio 1400 functionality may be controlled using the cellular phone 1300 and vice versa. Further, the weather band radio 1400 may be used to provide emergency alert messages to the cellular phone subscriber. Further, the weather band radio 1400 may be used to provide location specific emergency alert messages to the cellular phone subscribers. Further, the weather band radio 1400 may be used to broadcast text messages to cellular phone subscribers. Further, the cellular phone application may be used in the process of billing for the weather band radio 1400. Further, the cellular phone application may be realized with no loss of generality or specificity and implemented in parts or any combination of hardware, software, device driver, firmware, OS, etc.

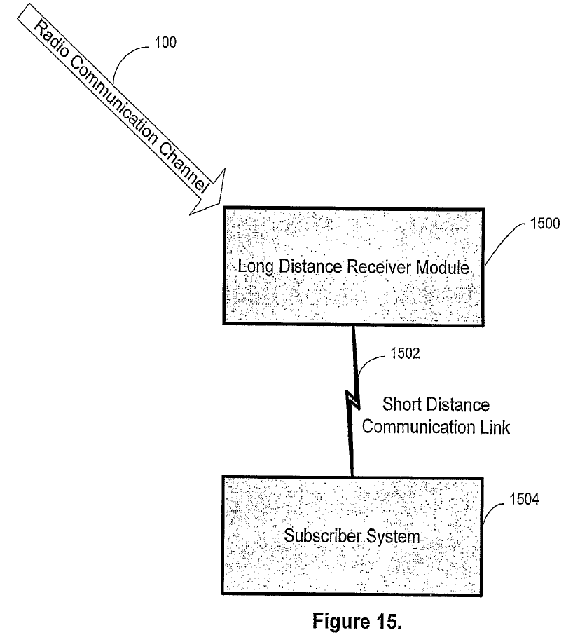

FIG. 15 is a conceptual diagram illustrating the communications device split into two or more separate modules. The long distance communication receiver module 1500 may be designed to receive messages broadcasted from but not limited to, and with no loss of generality or specificity, satellite, cellular station, FM/AM station, weather station, emergency beacon, airplane, etc. The long distance communication communications device 1500 communicates the received messages to the subscriber system 1504 using but not limited to, and in any parts or combinations of, wire or wireless link or both, Bluetooth link, Ethernet, 802.11, Wi-Max, fiber, cable, telephone, etc 1502. The subscriber system 1504 performs required decoding of the received message and alerts the subscriber when all the addressing criteria of the received message are satisfied by the communications device 102.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A communications device, comprising:
a receiver module configured to receive a message with location information;
a location module configured to determine the location of the communications device; and
an interface configured to provide the message to a user only when the communications device is within the location specified by the location information.

2. The communications device of claim 1 wherein the message is encrypted with the location information, the communications device further comprising a decryption engine configured to decrypt the message using a code based on the location of the communications device.

3. The communications device of claim 1 wherein the receiver module is further configured to receive information identifying a group for which the message is intended, the communications device further comprising a filter module configured to determine whether the communications device belongs to the group, and wherein the interface is further configured to provide the message to the user only when the filter module determines that the communications device belongs to the group.

4. The communications device of claim 3 wherein the group provides emergency services.

5. The communications device of claim 4 wherein the group that provides emergency services is police, fire, medical, or government.

6. The communications device of claim 3 further comprising a validation module having a key to authenticate the source of the message.

7. The communications device of claim 1 wherein the interface is further configured to provide the message to a display.

8. The communications device of claim 1 wherein the interface is further configured to provide the message to an audio device.

9. The communications device of claim 1 wherein the interface is further configured to provide the message to an automobile device.

10. The communications device of claim 1 wherein the interface is further configured to provide the message to a household appliance.

11. The communications device of claim 1 wherein the interface is further configured to provide the message to a public address system.

12. The communications device of claim 1 wherein the interface is further configured to provide the message to a nuclear, biological, and chemical (NBC) detector.

13. The communications device of claim 12 wherein the receiver module is further configured to receive a response to the message from the NBC detector.

14. The communications device of claim 1 wherein the interface is further configured to provide the message to the user by controlling a highway sign or traffic light.

15. The communications device of claim 1 wherein the receiver module is further configured to receive the message from a satellite.

16. The communications device of claim 1 wherein the receiver module is further configured to receive the message from a terrestrial broadcast station.

17. The communications device of claim 1 wherein the receiver module is further configured to receive the message from a cellular base station.

18. The communications device of claim 1 wherein the receiver module is further configured to receive the location information from a satellite.

19. The communications device of claim 1 wherein the receiver module is further configured to receive the location information from a terrestrial broadcast station.

20. The communications device of claim 1 wherein the receiver module is further configured to receive the location information from a cellular base station.

21. The communications device of claim 20 wherein the location information comprises a cellular site identifier, and wherein the location module determines the location of the communications device from the cellular site identifier.

22. The communications device of claim 1 further comprising a transmitter module configured to transmit a response to the message.

23. The communications device of claim 1 wherein the receiver module is further configured to receive information for different locations, the information for each of the different locations being assigned a unique channel within a broadcast, and wherein the interface module is further configured to provide to the user the message containing the information for the location of the communications device.

24. The communications device of claim 1 wherein the message comprises weather information.

25. The communications device of claim 1 wherein the message comprises advertising.

26. The communications device of claim 1 further comprising memory configured to store the message independent of the location of the communications device, and wherein the interface is further configured to provide the message to the user when the communications device enters the location specified by the location information.

27. The communications device of claim 1 wherein the message comprises an emergency alert message.

28. The communications device of claim 1 wherein the interface is further configured to interface the communications device to a consumer electronic device.

29. The communications device of claim 1 wherein the communications device comprises a cellular telephone.

30. The communications device of claim 1 wherein the receiver module is further configured to receive the location information on a first channel, and tune to a second channel to receive the message when the communications device is within the location specified by the location information.

31. The communications device of claim 1 wherein the message is subscriber specific, the communications device further comprising a subscriber identifier module configured to assign a subscriber identifier to the communications device based on the location of the communications device, and wherein the interface is further configured to provide the message to the user when the subscriber identifier assigned by the subscriber identifier module indicates that the subscriber specific message is for the receiving device.

32. The communications device of claim 1 wherein the location module is further configured to determine the location of the communications device using GPS.

33. The communications device of claim 1 wherein the location module is further configured to determine the location of the communications device from user inputs.

34. The communications device of claim 1 wherein the receiver module is further configured to receive a plurality of satellite signals, and wherein the location module uses time delays of the satellite signals to determine the location of the communications device.

35. The communications device of claim 1 wherein the receiver module is further configured to receive a beacon on a first channel, and tune to a second channel to receive the message when the communications device is within the location specified by the location information.

36. A communications device, comprising:
means for receiving a message with location information;
means for determining the location of the communications device; and
means for providing the message to a user only when the communications device is within the location specified by the location information.

37. A method of communications with a communications device, comprising:
receiving a message with location information;
determining that the communications device is within the location specified by the location information; and
providing the message to a user in response to the determination that the communications device is within the location specified by the location information.

38. The method of claim 37 wherein the message is encrypted with the location information, the method further comprising decrypting the message using a code based on the location of the communications device.

39. The method of claim 37 wherein the message is encrypted with the location information, the communications device further comprising a decryption engine configured to decrypt the message using a code based on the location of the communications device.

40. The method of claim 37 further comprising receiving information identifying a group for which the message is intended, and determining that the communications device belongs to the group, and wherein the message is provided to the user in response to the determination that the communications device belongs to the group.

41. The method of claim 40 wherein the group provides emergency services.

42. The method of claim 41 wherein the group that provides emergency services is police, fire, medical, or government.

43. The method of claim 40 further comprising authenticating the source of the message.

44. The method of claim 37 wherein the message is provided to a display.

45. The method of claim 37 wherein the message is provided to an audio device.

46. The method of claim 37 wherein the message is provided to an automobile device.

47. The method of claim 37 wherein the message is provided to a household appliance.

48. The method of claim 37 wherein the message is provided to a public address system.

49. The method of claim 37 wherein the message is provided to a nuclear, biological, and chemical (NBC) detector.

50. The method of claim 49 further comprising receiving a response to the message from the NBC detector.

51. The method of claim 37 wherein the message is provided to the user by controlling a highway sign or traffic light.

52. The method of claim 37 wherein the message is received from a satellite.

53. The method of claim 37 wherein the message is received from a terrestrial broadcast station.

54. The method of claim 37 wherein the message is received from a cellular base station.

55. The method of claim 37 wherein the location information is received from a satellite.

56. The method of claim 37 wherein the location information is received from a terrestrial broadcast station.

57. The method of claim 37 wherein the location information is received from a cellular base station.

58. The method of claim 57 wherein the location information comprises a cellular site identifier, and wherein the determination that the communications device is within the location specified by the location information is based on the cellular site identifier.

59. The method of claim 37 further comprising transmitting a response to the message.

60. The method of claim 37 further comprising receiving information for different locations, the information for each of the different locations being assigned a unique channel within a broadcast, and wherein the message provided to the user is the information for the location of the communications device determined by the location module.

61. The method of claim 37 wherein the message comprises weather information.

62. The method of claim 37 wherein the message comprises advertising.

63. The method of claim 37 wherein the message is received when the receiving device is outside the location specified by the location information, the method further comprising storing the message, and wherein the message is provided to the user when the communications device enters the location specified by the location information.

64. The method of claim 37 wherein the message comprises an emergency alert message.

65. The method of claim 37 further comprising interfacing wherein the interface is further configured to interface the communications device to a consumer electronic device.

66. The method of claim 37 wherein the communications device comprises a cellular telephone.

67. The method of claim 37 wherein the location information is received on a first channel, the method further comprising tuning to a second channel to receive the message.

68. The method of claim 37 wherein the message is subscriber specific, the method further comprising assigning a subscriber identifier to the communications device based on the location of the communications device, and wherein the message is provided to the user when the subscriber identifier assigned by the subscriber identifier module indicates that the subscriber specific message is for the receiving device.

69. The method of claim 37 wherein the location of the communications device is determined using GPS.

70. The method of claim 37 wherein the location of the communications device is determined from user inputs.

71. The method of claim 37 further comprising receiving a plurality of satellite signals, and the determination that the receiving device is within the location specified by the location information is determined from the time delays of the satellite signals.

72. The method of claim 37 further comprising receiving a beacon on a first channel, and tuning to a second channel to receive the message when the communications device is within the location specified by the location information.

73. Computer readable media containing a set of instructions for a processor in a receiving device to communicate, the receiving device being configured to receive a message with location information, the instructions comprising:
a routine to determine the location of the communications device; and
a routine to provide the message to a user only when the communications device is within the location specified by the location information.

74. The computer readable media of claim 73 wherein the message is encrypted with the location information, the instructions further comprising a routine to decrypt the message using a code based on the location of the communications device.

75. The computer readable media of claim 73 wherein the communications device is further configured to receive information identifying a group for which the message is intended, the instructions further comprising a routine to determine whether the communications device belongs to the group, and wherein the routine to provide the message to the user is configured to provide the message to the user only when it is determined that the communications device belongs to the group.

76. The computer readable media of claim 75 wherein the instructions further comprise a routine to authenticate the source of the message.

77. The computer readable media of claim 73 wherein the communications device is further configured to receive the location information from a cellular base station, and wherein the routine for determining the location of the receiver uses the cellular site identifier.

78. The computer readable media of claim 73 wherein the communications device is further configured to receive information for different locations, the information for each of the different locations being assigned a unique channel within a broadcast, and wherein the routine to provide the message to the user is configured to provide to the user the information for the location of the communications device.

79. The computer readable media of claim 73 wherein the message comprises weather information.

80. The computer readable media of claim 73 wherein the message comprises advertising.

81. The computer readable media of claim 73 wherein the communications device further comprises memory configured to store the message independent of the location of the communications device, and wherein the routine to provide the message to the user is configured to provide the message to the user when the communications device enters the location specified by the location information.

82. The computer readable media of claim 73 wherein the message comprises an emergency alert message.

83. The computer readable media of claim 73 wherein the communications device is further configured to receive the location information on a first channel, the instructions further comprising a routine to tune the communications device to a second channel to receive the message when the communications device is within the location specified by the location information.

84. The computer readable media of claim 73 wherein the message is subscriber specific, the instructions further comprising a routine to assign a subscriber identifier to the communications device based on the location of the communications device, and wherein the routine to provide the message to the user is configured to provide the message to the use the assigned subscriber identifier indicates that the subscriber specific message is for the receiving device.

85. The computer readable media of claim 73 wherein the routine to determine the location of the communications device uses GPS.

86. The computer readable media of claim 73 the routine to determine the location of the communications device uses inputs from the user.

87. The computer readable media of claim 73 wherein the communications device is further configured to receive a plurality of satellite signals, and wherein the routine to determine the location of the communications device uses time delays of the satellite signals.

88. The computer readable media of claim 73 wherein the communications device is further configured to receive a beacon on a first channel, the instructions further comprising a routine to tune the communications device to a second channel to receive the message when the communications device is within the location specified by the location information.
